(19) United States
(12) Patent Application Publication
(10) Pub. No.: US 2017/0042378 A1
(43) Pub. Date: Feb. 16, 2017

(54) Cooking Apparatus and Heat Tent

(71) Applicant: BBKEG Inc., Toronto (CA)

(72) Inventor: Ryan Swiderski, Toronto (CA)

(73) Assignee: BBKEG Inc., Toronto (CA)

(21) Appl. No.: 15/229,870

(22) Filed: Aug. 5, 2016

Related U.S. Application Data
(60) Provisional application No. 62/204,643, filed on Aug. 13, 2015.

(51) Int. Cl. A47J 37/07

(52) U.S. Cl. CPC A47J 37/0763

(57) ABSTRACT

A cooking apparatus is provided, comprising: a base and a lid; gas burners in the base; a grill for supporting food located above the burners; a gas supply line to the burners; a controller for controlling gas flow to the burners; an igniter to ignite the gas; and a heat tent located above one of the burners. The heat tent has an interior volume having an open side and a wall defining a top side opposite the open side. The top side has a peak extending away from the open side. The heat tent is movable to: a first position where the top side faces upward providing a shield for the burner from drippings falling from the food being cooked; and a second position where the top side faces downward and the open side face upward providing trough to hold wood chips for producing smoke for the food.

### RELATED APPLICATION

This application is related to U.S. provisional application Ser. No. 62/204,643 filed on Aug. 13, 2015.

### FIELD OF DISCLOSURE

The present disclosure relates generally to the field of cooking apparatuses and features and accessories provided therein.

### BACKGROUND OF THE DISCLOSURE

There are many designs of barbecues, smokers, and similar types of cooking apparatuses. Barbecues, smokers and the like are often used in outdoor sports-related settings such as “tailgate parties”, where beer, oftentimes served from beer kegs, is frequently also served.

### SUMMARY OF THE DISCLOSURE

In a first aspect, a cooking apparatus is provided. The apparatus comprises: a base and a lid forming two complimentary sections of a structure, such that when the base and lid are closed, a substantially horizontal cylindrical cooking chamber is defined within the base and lid; one or more gas burners fitted to sit within the base; a grill for supporting food fitted to sit above the one or more gas burners; and a heat tent located above a burner of the one or more gas burners. The heat tent is shaped to have an interior volume having an open side and a wall defining a top side opposite the open side, wherein the top side is shaped to have a peak extending away from the open side. The heat tent is movable to: a first position where the top side faces upward providing a shield for the burner from drippings falling from food being cooked above the heat tent; and a second position where the top side faces downward and the open side face upward providing trough to hold wood chips for producing smoke for the food being cooked.

In the heat tent, the wall of the heat tent may form a V cross-section or a part of a semi-circular cross-section.

In the heat tent, the wall of the heat tent may further comprise two side walls extending from the open side that are each connected to the top side.

The heat tent may further comprise: an end cap on each anterior end of the heat tent, the end cap having a first hole therein; a bracket attached to the base above the burner, the bracket having a second hole therein; and a bolt inserted through the first hole and the second hole providing a friction fit for the heat tent within the base. The heat tent may be rotatable between the first and the second positions about the bolt.

The heat tent may further comprise a screen for the heat tent, located on the open side of the heat tent. The screen may further be attached to the heat tent with a hinge.

In a second aspect, a heat tent for covering a burner in a cooking apparatus is provided. The heat tent comprises: a wall shaped to have an interior volume having an open side and a wall defining a top side opposite the open side. The top side is shaped to have a peak extending away from the open side. The heat tent is movable in the cooking apparatus to: a first position where the top side faces upward providing a shield for the burner from drippings falling from food being cooked located above the heat tent in the cooking apparatus; and a second position where the top side faces downward and the open side face upward providing trough to hold wood chips for producing smoke for the food being cooked.

Another aspect of the disclosure provides a cooking apparatus comprising a base and a lid, the lid capable of being opened and closed in relation to the base such that when the lid is closed on the base, the base and lid together form a substantially horizontal cylindrical cooking chamber; one or more gas burners fitted to sit within the base; a grill for supporting food fitted to sit above the one or more gas burners; a means to supply gas to the one or more gas burners; a means to control the flow of gas to the one or more gas burners; and a means to ignite the gas when it is flowing through the one or more gas burners.

In another broad aspect of the disclosure, there is provided the cooking apparatus described above, wherein the cooking chamber is constructed from a structure resembling a beer keg, such that when the base and lid are closed, the cooking chamber resembles a beer keg.

In another broad aspect of the disclosure, there is provided the cooking apparatus described above wherein the cooking chamber is constructed from a beer keg.

In another broad aspect of the disclosure, there is provided the cooking apparatus described above, wherein the cooking chamber is constructed from a standard 58.66 Litre beer keg.

In another aspect of the disclosure, there is provided a rotatable heat tent for use in a cooking apparatus which is shaped so that it is generally convex on one side, and generally concave on the other, and which is rotatable such that the convex side may face generally upward or generally downward.

In another broad aspect of the disclosure, there is provided the rotatable heat tent described above, wherein, when the rotatable heat tent has been rotated so that the convex side faces generally downward, the concave side may be used as a trough.

In other aspects, various combinations of sets and subsets of the above aspects are provided.

### BRIEF DESCRIPTION OF THE DRAWINGS

The foregoing and other aspects of the disclosure will become more apparent from the following description of specific embodiments thereof and the accompanying drawings which illustrate, by way of example only, principles of the disclosure. In the drawings:

FIG. 1 is a front view of an apparatus according to one embodiment in a closed position;

FIG. 2 is a back view of the apparatus of FIG. 1 shown in a closed position;

FIG. 3 is a top view of the apparatus of FIG. 1 shown in a closed position;

FIG. 4 is a bottom view of the apparatus of FIG. 1 shown in a closed position;

FIG. 5 is a left side view of the apparatus of FIG. 1 shown in a closed position;

FIG. 6 is a right side view of the apparatus of FIG. 1 shown in a closed position;

FIG. 7 is a perspective view of the apparatus of FIG. 1 shown in a closed position;

FIG. 8 is a perspective view of the apparatus of FIG. 1 shown in an open position, showing a grill therein;

FIG. 9 is another perspective view of the apparatus of FIG. 8 with heat tents and with the grill removed;

FIG. 10 is another perspective view of the apparatus of FIG. 10 with the heat tents rotated to an access position;

FIG. 11 is a perspective view of another embodiment of an apparatus where a handle and knobs of a control panel are removed from view; and

FIG. 12 is a perspective view of yet another embodiment of an apparatus where a handle and of a control panel are removed from view.

### DETAILED DESCRIPTION OF AN EMBODIMENT

The description which follows, and the embodiments described therein, are provided by way of illustration of an example, or examples, of particular embodiments of principles of the present disclosure. These examples are provided for the purposes of explanation, and not limitation, of those principles and of the disclosure. In the description, which follows, like parts are marked throughout the specification and the drawings with the same respective reference numerals.

For reference, directional terms such as “left”, “right”, “top”, “bottom”, “up”, “upward”, “down” and “downward” describe locations/positions relative to a user facing the front of an embodiment (i.e. the cooking apparatus), unless otherwise noted or otherwise made plain by the context of the use of the term.

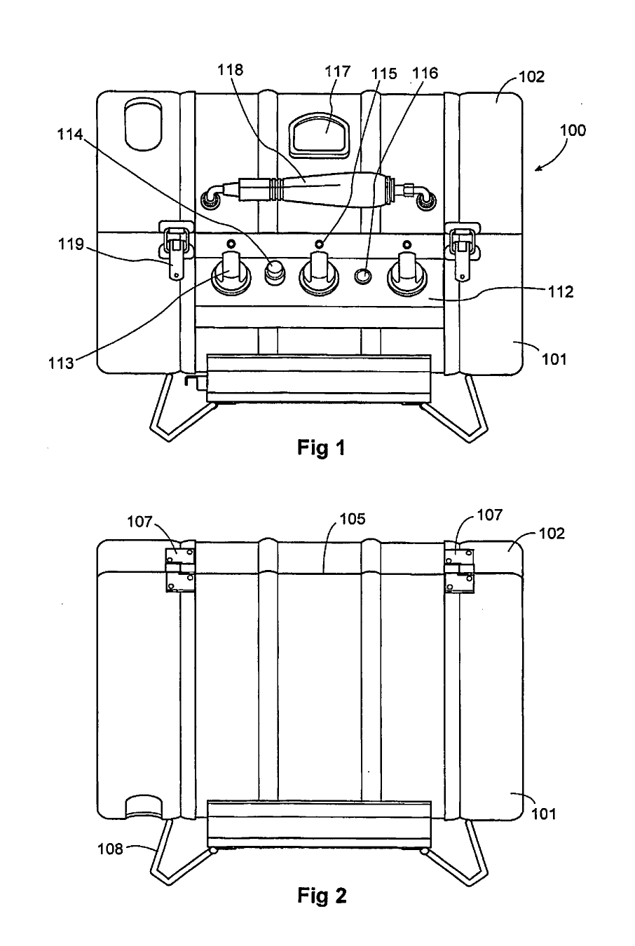

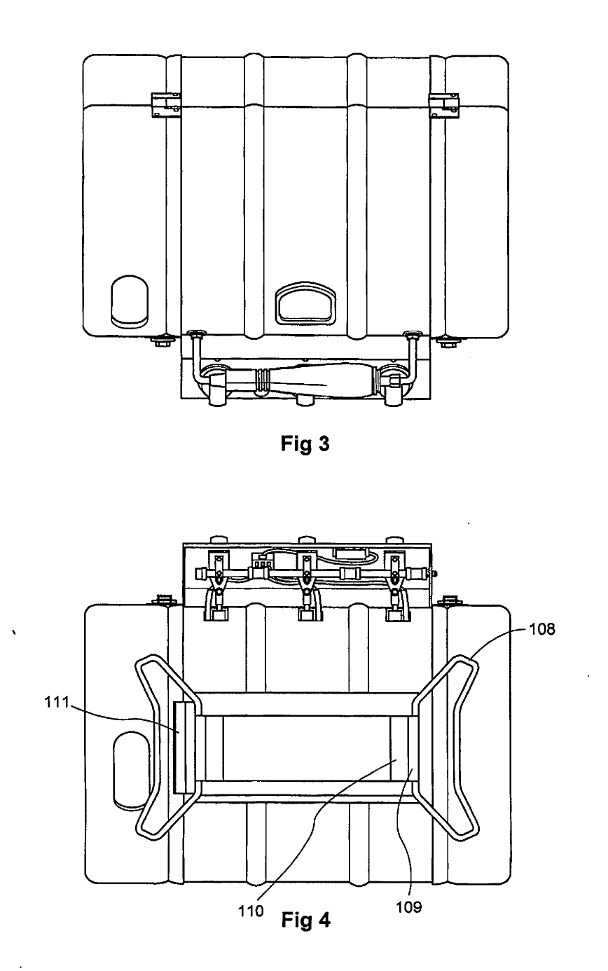

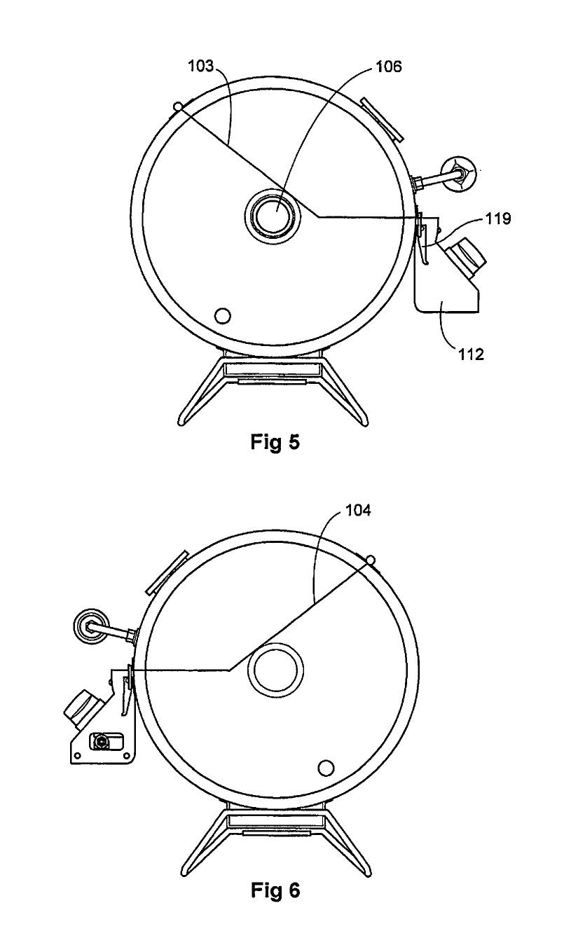

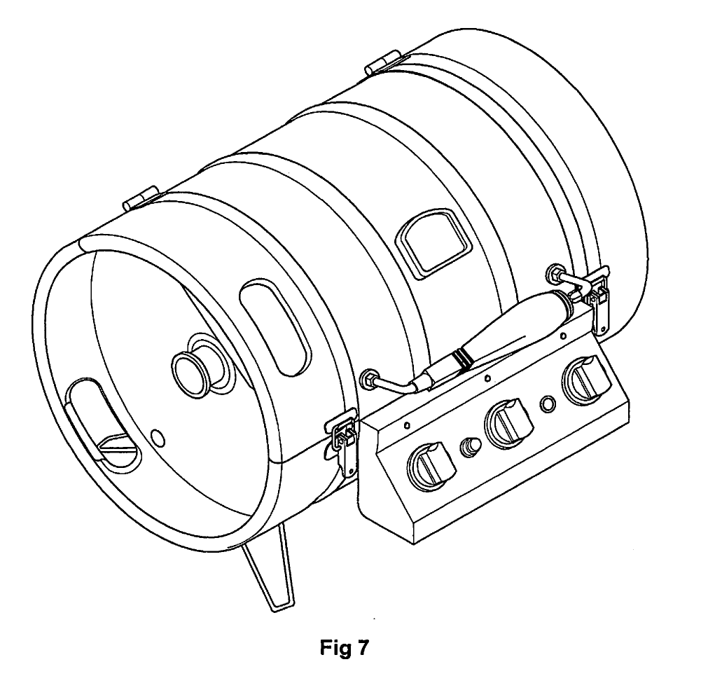

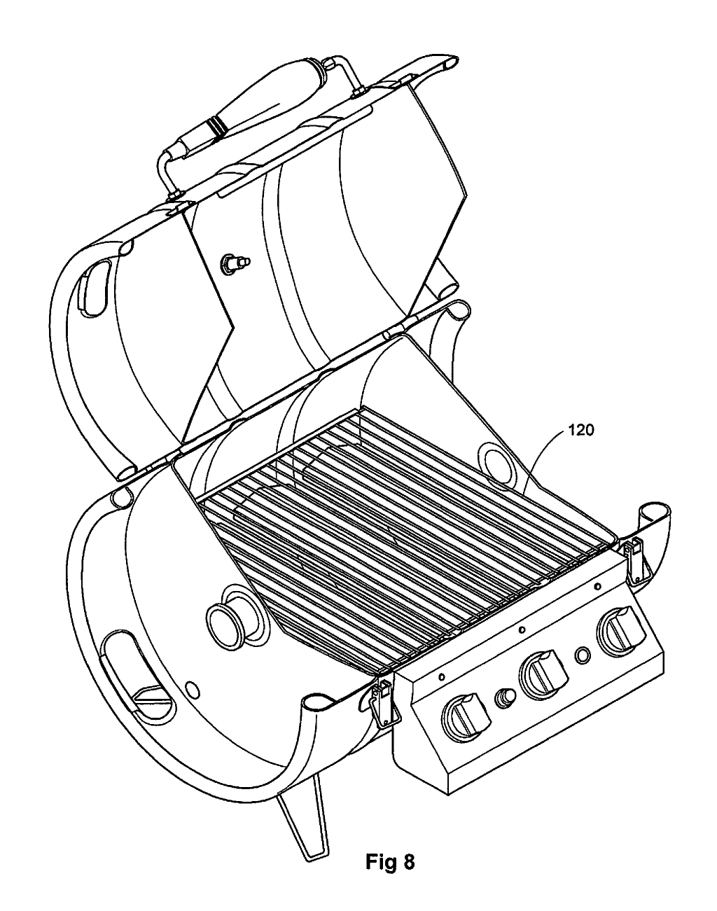

FIG. 1 shows the apparatus of an embodiment of the disclosure from a front view. The apparatus is constructed from a beer keg, or a vessel resembling a beer keg. In the embodiment shown, a 58.66 L or 15.5 US Gallon beer keg which has been constructed as per industry standards is used for keg body 100. In one embodiment, a recycled beer keg can be used as the form. In another embodiment, a facsimile of a form of a beer keg can be used. In still another embodiment, a different form can be provided. The beer keg comprises keg body 100 oriented to be on its side with the top side on the left side and is shown as cut into two pieces to create base 101 and lid 102. In other embodiments, the top side can be positioned to be on the right side. With reference to FIGS. 5 and 6, the cuts are described as follows. There is cut 103 on the left side surface of keg body 100 which travels along the radius of the left side of the keg body 100 toward the centre of covered neck 106, which cut then comprises a 45 degree angle which runs to the back of keg body 100. Identical cut 104 is on the right side of the apparatus. As shown in FIG. 2, straight line cut 105 connecting left side cut 103 and right side cut 104 is across the back surface of keg body 100 and there is also a straight line cut across the front surface of the keg body 100 connecting left side cut 103 with right side cut 104. It will be seen that the cuts in keg body 100 produce two (or more) complementary separate pieces that fit together to retain the general shape of the original vessel (e.g. a beer keg or a facsimile of a beer keg).

While this specific cut has been described herein, it will be appreciated that other cut patterns may be used to produce other configurations of bases and fitting lids. A cut parallel to grill 120 travels from the front of the cooking apparatus some distance before being intersected by an angled cut or some other cut that finishes on a plane above the cut parallel to the grill 120. The locations of cut 103 and cut 104 influence fluid flow, more specifically the flow of exhaust gas carrying heat used for cooking. Exhaust gas carrying heat will discharge by flowing to a nearest exit point or any break in keg body 100 that air is allowed to flow through from within keg body 100 above the grill 120. Utilising the cylindrical shape of keg body 100, and by forcing the exhaust gas to exit at a point generally above grill 120 creates a convections of (heated) air-flow for convention-cooking that utilises less fuel while retaining more heat. Further, appropriate alterations can be made to keg body 100 such as but not limited to cuts, punctures, holes, and welds to fit components and allow matter in and by products out. Further, pre-built beer kegs that either have or do not have a Sankey valve may be used as the initial form for keg body 100.

Base 101 and lid 102 are connected by hinges 107 at their complementary back edges allowing lid 102 to open and close and to remain attached to base 101. In addition to this primary function, hinges 107 may be spaced and mounted between base 101 and lid 102 to leave a gap between base 101 and lid 102, which acts as a vent to allow exhaust out from the apparatus when cooking. Lid 102 may swing upward and back about hinges 107 when opened by the user. In order to prevent lid 102 from opening wider than desired (e.g. to a position where handle 118 on lid 102 out of convenient or safe reach to the user), movement restriction stops may be fabricated and fastened to hinges 107. Each stop consists of a small protruding piece fastened to hinge 107 that pushes up against keg body 100 at a designed point to impede and prevent lid 102 from opening any wider. Other stop mechanisms can be installed between base 101 and lid 102, such as lid support hinges and other mechanical stop devices.

Base 101 may be attached to legs to allow the apparatus to stand on surfaces without rolling. In the present embodiment two legs 108 are constructed from stainless steel rods, bent to match a template pattern, though it will be appreciated that other materials and patterns may be used to construct legs 108.

Legs are held in place by bracket 109 that secures them to grease tray support 110 while allowing them to rotate from an “in” position, while not in-use (i.e., during transport), to an “out” position that supports the keg on a surface (e.g., table top, ground, pick-up truck flat bed, etc.). Each leg has two or more points of contact with the apparatus and two or more points of contact with the support surface. Legs 108 are able to rotate in a sleeve portion of the bracket.

Grease tray support 110 is a structural component cut to shape and bent to a form to fit under base 101 and within the legs. One structural function of grease tray support 110 when it is fastened to base 101 is to provide structural support for the apparatus. As well as providing support it elevates the apparatus to allow air flow in through openings in base 101 to the burners. The form of support 110 and grease tray 111 is complementary and fitting, so that tray 111 can slide and sit in position in order to collect grease drippings and debris that fall through the openings in base 101. A hitch attachment is designed to securely fasten onto the grease tray support for transport and use. In one embodiment, the dimensions of grease tray support 110 and legs 108 are such that grease tray 111 can be removed while legs 108 are folded out or while the cooking apparatus is in use, meaning that grease and other debris can be removed with ease.

In the present embodiment, grease tray 111 is cut and bent into a shape that fits snugly in grease tray support 110 directly underneath base 101 where holes in base 101 are present to allow grease drippings and debris to collect and fall through. Given the cylindrical shape of keg body 100, grease drippings and debris collect in the minimum. In addition to the cylindrical minimum of keg body 100, ribs protrude further out from the cylindrical shape making them the lowest points in base 101. Utilising this shape, grease drippings and debris are funneled into the ribs where holes have been placed in base 101 to drain the grease drippings and debris into grease tray 111. Grease tray 111 can be removed while legs 108 are in the “out” or “in” positions, which is an improvement over other cooking apparatus designs.

In the present embodiment, control panel 112 is attached to base 101. In one embodiment, panel 112 may be fabricated from stainless steel sheet metal cut, bent, drilled, welded and fastened into position on base 101, though it will be appreciated that other materials can be used for the control panel, and that it can be attached to other parts of the apparatus. Control panel 112 has two main functions. The first function is to conceal the manifold and working components. The second function is to display the operating controls to the user(s) including but not limited to control knobs 113, igniter button 114, and display lights 115 and button 116. In addition, control panel 112 is a structural component of the apparatus due to the function of holding working components in place. It should be noted that the number of control knobs does not necessarily correlate with the number of burners, and vice versa.

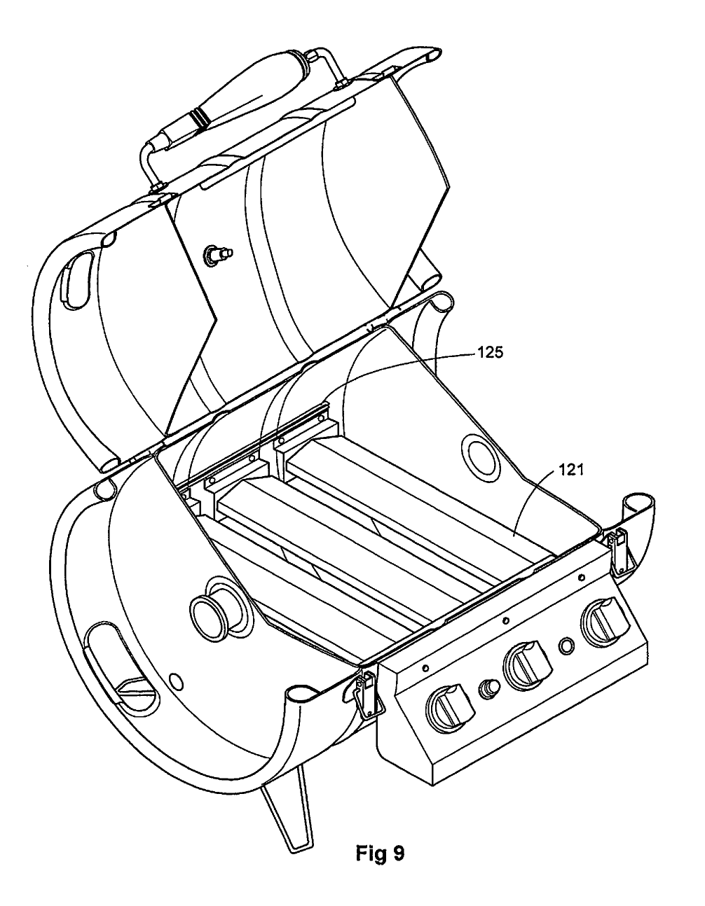

Lid 102 may be fitted with temperature gauge 117 and handle 118. It will be appreciated that temperature gauge 117 is optional, and may be placed in other locations on keg body 100. A standard barbecue temperature gauge may be used. Handle 118 can be a formed as a basic bar that it attached at its ends to lid 102 to form a typical barbecue handle. Notably FIG. 7 shows a handle that has been formed from a beer tap having a threaded rod formed to be inserted in its top end then bend and travel towards and through the lid to be secured by lug nuts on its opposite end, which permits attachment and detachment of the handle from lid 102.

Lid 102 and base 101 may also optionally be fitted with one or more fasteners 119 which allow for lid 102 and base 101 to be fastened together, to prohibit unintended opening of the apparatus. This may be desirable to facilitate travel and storage of the apparatus.

As described in more detail below, keg body 100 may be fitted with one or more gas burners to function as a cooking apparatus. Such burners may be controlled by one or more control knobs 113 and lid 102 can be opened or closed to further control and regulate cooking temperatures and environment.

FIG. 8 shows the apparatus in an open position. As may be seen in FIG. 8, grill 120 fits inside base 101 and is held in place by channel bracket 125 at the back of base 101 supporting grill 120 both from below and above. At the front edge of base 101, grill 120 is supported from below by bracket 126. Grill 120 is used to support food being cooked within the apparatus. When lid 102 is closed bracket 127 on the inside front edge of lid 102 pushes down on grill 120. When fitted fasteners 119 are latched, grill 120 is locked into position firmly held between both bracket 126 and bracket 127 while remaining in place in channel bracket 125 restraining grill 120 from any movement, convenient for transport.

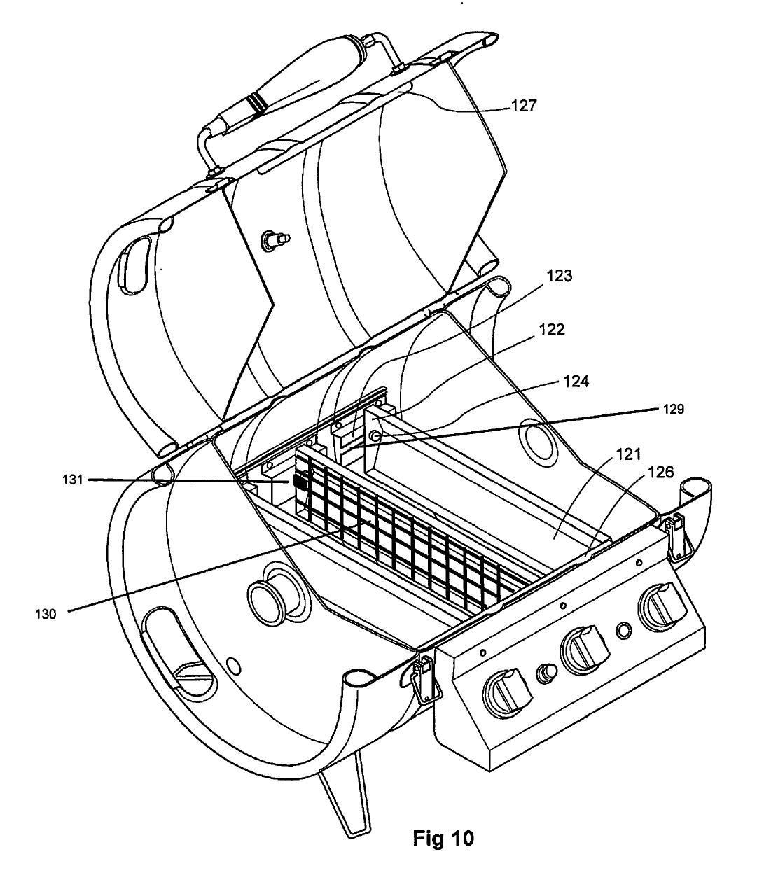

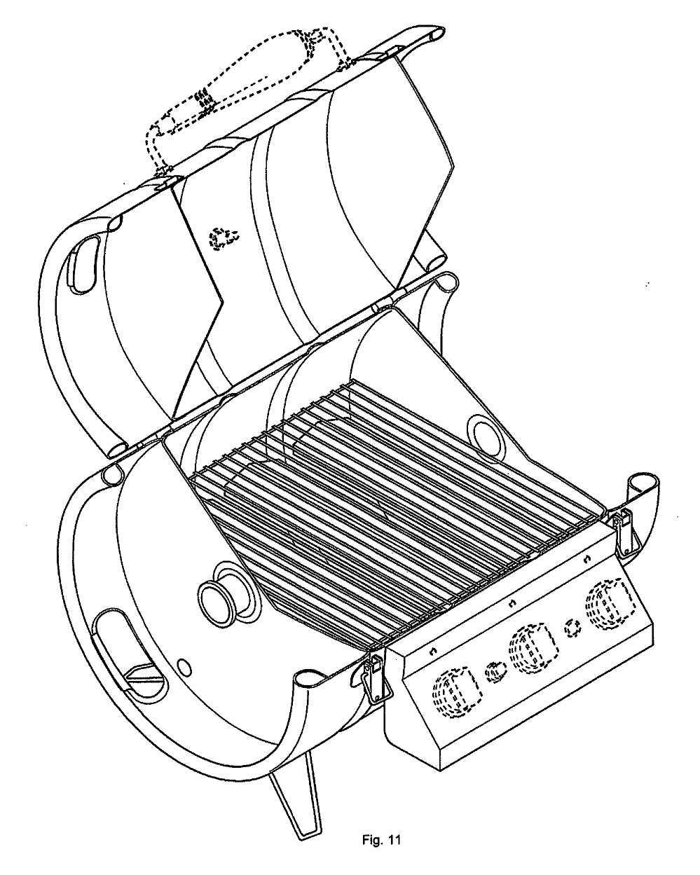

FIGS. 9 and 10 show apparatus with grill 120 removed for ease of reference to show features of heat tents 121. Three heat tents 121 are shown in base 101 and each heat tent 121 is located above a respective burner. These heat tents 121 may be formed from non-structural stainless steel that is cut and shaped to have a concave side and a convex side. In FIGS. 9 and 10, the shape resembles an elongated, irregular pentagon, having an open side, with relatively short opposing sides extending from the open side and two top sides that are longer and converge towards each other from each end of the open side to an apex that is away from the open side. As shown, the apex runs in a line across the top of heat tent 121, and the open side is located on the bottom of heat tent 121 (opposite the apex). It will be seen that an interior volume of the heat tent is formed from the sides and the top side. Each end of heat tent 121 is capped with end caps 122, with the bottom of heat tent 121 remaining open to form the open side. Two mounting brackets 123 per heat tent 121 may be constructed of similar metallic or heat resistant materials and fastened to base 101 above the burners for mounting the heat tents thereto.

In one embodiment heat tent 121 is rotatable and/or movable about its longitudinal axis over its burner. In one embodiment, to facilitate rotation and/or movement of heat tent 121 over its burner, a hole is provided on each end cap 122 with screw or bolt 124 fitted therethrough. On bracket 123 a corresponding hole is provided to the relevant hole on end cap 122 in an axial alignment. As such, bolt 124 may be inserted through both holes and secured on its exterior end with a fitted nut to secure the relevant bracket 123 to end cap 122. In one configuration, the head of the bolt is located inside heat tent 121; in another configuration, the head of the bolt is located outside bracket 123. There is a friction fit created among bolt 124 (appropriately threaded to the nut), end cap 122 and bracket 123. The friction fit permits rotation of heat tent 121 about bolt 124, but where heat tent 121 otherwise remains fixed in its rotational position after being rotated.

Other mechanical arrangements may be provided that permit heat tent 121 to be moved and/or rotated into various positions above its burner. For example, brackets 123 may have notch 129 therein extending from one of its edges (either a vertical edge or horizontal edge) to the hole in bracket 123 that receives bolt 124. The hole may be located slightly below the notch, but still connected to the notch. This permits removal of that end of heat tent 121 from that bracket 123, which then permits heat tent 121 to be rotated to another orientation and then reinserted to the hole of bracket 123 via the notch. When there is a corresponding notch in the opposite bracket 123, this facilitates removal of heat tent 121 from base 101. The notch may or may not be angled in its path from the edge to the hole. The notch may have straight sides, curved sides, connected segments of sides or any combination thereof.

The axial mounting allows heat tent 121 to be rotated and/or moved to any number of degrees around its longitudinal axis. One embodiment of rotatable/movable heat tent 121 provides two orientations and functions. First, when the open side of heat tent 121 faces downward towards its burner and the top side faces upward, the two sides and the top side of heat tent 121 form a cap that protect the burner (located beneath heat tent 121) from flare-ups caused from drippings (e.g. grease) that may fall from food being cooked on grill 120 by deflecting those dripping away from the burner and its open flames. Second, when rotated at or near to 180 degrees (relative to base 101), heat tent 121 has an orientation where its open side faces upward with the top side faces downward so that the two sides and the top side define a volume within heat tent 121 that forms a trough. The size and shape of the trough is suitably formed by heat tent 121 so that it can hold smoking wood chips, which may be heated by the burner directly below and create smoke flavouring the food, for example, and for other cooking applications. As well, the overall footprint of heat tent 121 may be designed to have a suitable dimension to cover and protect one or more burners or other features that are located below it.

In a third orientation, heat tent 121 may be oriented so that it is in a generally vertical orientation about its longitudinal axis. This allows physical access to features beneath heat tent 121, including its burner, which may facilitate maintenance and cleaning of those features.

Additionally, alignment notches may be provided on bolt 124 with corresponding tabs provided on the interior perimeter of the hole on the corresponding bracket 123 to provide one or more pre-set rotation positions for heat tent 121 about bracket 123. The location of the notches and tabs may be interchanged between bolt 124 and bracket 123 (or on other features of heat tent 121).

As well, one bolt 124 may extend outwardly from its end cap 122 through an aperture in base 101 and extend outside the body of base 101 where it is connected to a knob, which can be turned by a user to facilitate rotation of heat tent 121 by the user. Bolt 124 may also be connected to a motor that is controlled by the user to motorize rotation of heat tent 121.

FIG. 10 shows heat tents 121 being oriented along a transverse plane of the longitudinal axis of base 101. In other embodiments where the burners are positioned extending along the longitudinal axis of base 101, corresponding heat tents 121 may also be oriented along that longitudinal axis. In still other embodiments, one or more heat tents 121 may be oriented not along either the longitudinal or transverse axes of base 101.

It will be seen in an apparatus that has two or more burners with corresponding heat tents, as each heat tent is independently moveable/rotatable to a desired position, it is possible to set one (or more) heat tent to be in a heat shield orientation to protect its burner, while one (or more) of the other heat tents is set to be in a smoker orientation to hold chips for smoking while the other burner is used (primarily) to cook food.

While heat tents 121 of FIGS. 9 and 10 are shown as having the above-noted pentagonal cross-sectional shape, it will be appreciated that in other embodiments, other cross-sectional shapes for heat tents may be used that still provide two functions of shielding from heat in one orientation and defining a trough-shaped volume in a second orientation. A general feature of the shape of a heat tent for an embodiment shown in FIGS. 9 and 10 is that the cross-sectional shape of heat tent 121 forms an interior volume defined by one or more walls of heat tent 121, with an open side on the bottom side of heat tent 121, two sides (of the walls) extending from the open side and a top side (of the walls) opposite the open side that is connected to each of the two sides. The top side is shaped to have a peak or apex extending away from the open side.

It will be appreciated that forms of alternative heat tents are provided. For example, a heat tent may have a generally semi-circular cross-section or a segment of a semi-circle (as a single wall). Alternatively, a heat tent may have a V cross-section (as two spaced walls converging at an apex). In a broad sense, a heat tent of an embodiment has its top side shaped to be concave as viewed from outside heat tent. The interior volume of that heat tent has the top side shaped to be convex as viewed from its inside. As such, when the heat tent is oriented to have its top side facing upward, the top side shields the burner(s) underneath and deflects things, such as grease drippings, coming from the above grill, from the burner(s) and other items protected by the heat tent. When the heat tent is oriented to have its top side facing downward, the trough formed by the interior volume can retain materials contained therein for smoking. The perimeter of the cross-section of the heat tent may be solid, but there may be holes or gaps therein.

Also, materials other than steel may be used for the heat tents. The wall(s) of the heat tents may be formed from separate sheet(s) of metal and/or may be stamped from a single sheet of metal. As well other techniques of fastening various heat tents to base 101 to allow rotation or movement of these heat tents may be used.

Screen 130 may be affixed onto the open side of heat tent 121 to retain chips in heat tent 121 when it is rotated to positions where such chips may fall out of the open side of heat tent 121. Screen 130 may be made from metal and may be a stamped piece of metal or may be formed from a series of connected/welded vertical and horizontal bars/wires. Screen 130 may be shaped and configured may have any sized openings to accommodate retaining different sizes of wood chips. It may be as fine as a mesh. The size and number of openings may vary within screen 130. Screen 130 may fit with the open side of heat tent 121 through a friction fit with one or more of its edges in friction contact with one or more corresponding edges of sides of heat tent 121. Screen 130 may be fastened or secured to heat tent 121 with suitable fasteners (e.g. screws or bolts, not shown) or may be welded to heat tent 121. Screen 130 may be attached to heat tent 121 with hinge 131 at one of its ends. Screen 130 may extend along the entire opened length of heat tent 121 or a part thereof. Screen 130 may be detachable from heat tent 121 to allow insertion of chips into the trough and then remounted to tent 121 (as shown).

Given the appealing appearance of the apparatus, it will be appreciated that various marketing and licensing opportunities may arise, and so the apparatus may lend itself to branding (such as with the handle, as discussed above) and other cosmetic or licensing alterations. For example, a bottle opener could be affixed to keg body 100.

Other functional that may be added include a heat shield between base 101 and control panel 112. Given the heat sensitivity of the electrical components contained under control panel 112, a heat shield either constructed of an insulating material, sheet metal, or some combination of both may be incorporated utilising measured temperatures in relevant areas around control panel 112.

As well, an embodiment may provide a heat shield and draft wall on the inside of lid 102. In order to prevent discoloration of the lid a heat shield either constructed of an insulating material, sheet metal, or some combination of both may be incorporated. In addition, to this heat shield, an air gap may be incorporated between the lid and the heat shield to force the heated air to travel to the front of the barbecue before exiting out the back.

A further embodiment provides mounting attachments to be affixed to keg body 100 to allow it to be attached and unattached to other objects, such as vehicles, railings, or stands.

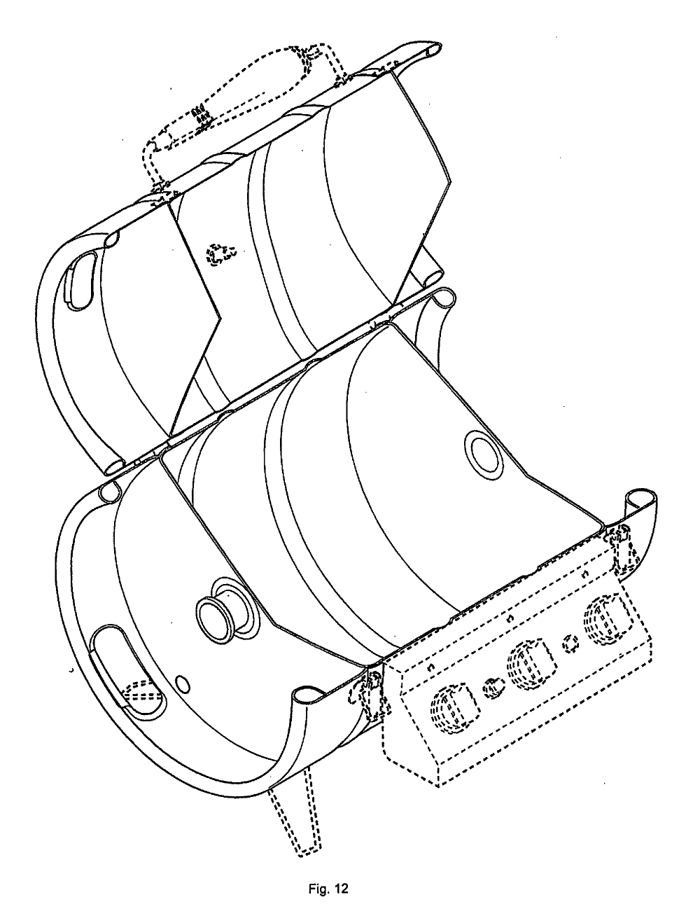

FIGS. 11 and 12 show aspects of other embodiments where different design features are shown as alternatives to design features shown in FIG. 8. FIG. 11 shows an embodiment of a design of an apparatus with a control panel, but without a handle and without a temperature gauge. FIG. 12 shows an embodiment of a design of an apparatus without a control panel, without a handle, and without a temperature gauge. Other variants on designs of an embodiment are envisioned. As noted above, for example, the top of the keg may be oriented to be on the right side with one or more of the other components mounted in a location as shown in FIG. 8.

### Example

The following example illustrates features of one embodiment of the present disclosure, and is provided for the purposes of explanation, and not limitation, of the present disclosure.

For the keg body, a 58.66 L or 15.5 US Gallon beer keg as per construction by industry standards may be used. The keg can be cut into two pieces to act as a base and lid. Other appropriate alterations such as, but not limited to, cuts, punctures, holes, and welds were made to allow interior components (e.g. grills, heat tents, gas lines) fit in the interior of the body and provide proper circulation, ventilation and exhaust of air, gas, and smoke in and out of the body.

Two legs made from a 5/16″ stainless steel rod, approximately 37″ in length, are were bent to match a template pattern. The legs are held in place by a bracket that secures them to the grease tray support while allowing them to rotate from an “in” position, while not in-use (i.e. during transport), to an “out” position that supports the apparatus on a floor (i.e. a table top). Each leg may have two points of contact with the apparatus and one, two or three points of contact with the floor.

Two brackets made from stainless steel sheet metal cut to shape and bent to pattern are added. The function of each bracket is to secure the leg to the grease tray support while allowing the leg to rotate in a sleeve between the “in” position and “out” position. Brackets can be welded or mechanically fastened to the grease tray support.

A grease tray support is provided, which provides structural support. It is made of stainless steel sheet metal cut to shape and bent to pattern. The function of the grease tray support is to be fastened to the base to support the apparatus in an upright position for use through the legs that are thus attached to it. The support also elevates the apparatus to allow air flow in through openings in through the bottom to the burners. A complementary grease tray is provided that is fit to slide and sit in position in order to collect grease drippings and debris that fall through the openings in the base. A hitch attachment is provided to securely fasten onto the grease tray support for transport and use.

The grease tray may be constructed from non-structural stainless steel sheet metal cut and bent into shape and fastened (corners welded). This slides into place within the grease tray support directly underneath holes in the base. The grease tray can be removed while the legs are “out” or “in”. The purpose is to collect waste by-products that accumulate in the base and dispose of them as desired.

A control panel is provided and may be fabricated from stainless steel sheet metal cut, bent, drilled, welded and fastened into its location. The control panel has two main functions: first, to conceal a manifold and working components; and second, to display the operating controls to the user(s) including but not limited to control knobs, igniter button, and display lights and button. In addition, the control panel is a structural component of the barbecue due to function of holding working components in place.

The manifold may be formed from tubing with welds capping one end and securing a flare nipple to the other. Holes may be drilled where gas is expected to flow from the tubing into the valves. The function of the manifold is to transport gas from the supplying gas hose connected at the flare nipple to the valves of the apparatus.

The apparatus may use three valves, one for each burner. The function of the valve is to take gas from the manifold and when opened by the user, deliver it to the burners. Each valve is fastened to both the manifold and the control panel. Valves have a stem that extends out through the control panel where a control knob is fitted on top. At the end of a valve is an orifice that has an opening that is suitably sized to expel gas into the burner in a desired quantity.

The apparatus may attach control knobs and bezels, one for each valve. Each control knob uses a bezel and makes up the control knob configuration. The control knobs are fitted to the valve stems on which they sit. Control knobs may be fitted to the stems of the valves and with bezels. Control knobs function as an interface for users to open, control the volume, and close the gas flow to its respective burner as desired. A bezel performs both a function and a form. As a function it is fastened to the control panel and oftentimes secures the valve to the control panel. As a form, it acts as a skirt concealing the portion of the valve stem that the control knob leaves exposed in order to rotate.

The apparatus may use a gas hose that comes fitted with a gas regulator. The function of the gas hose is to transport gas from the tank or gas supply to the manifold of the barbecue, but not before passing through the regulator. The function of the regulator is as a safety device engineered to control the flow of gas from the supply to the barbecue to prevent uncontrolled fires and explosions.

The embodiment uses an electronic igniter. An electronic igniter system may be provided with the number of ports corresponding to the number of burners. The function of the electronic igniter is to send an electric current from a power supply, such as a battery, through a wire to an electrode and jumps across to the burner in the form of a spark. When flammable gases are being emitted from the burner in close proximity the spark will ignite a fire. A button to produce the spark may be mounted on the control panel and is directly connected to the housing unit of the electronic igniter. A power supply such as a battery may be housed in the electronic igniter and may be replaced as necessary by unscrewing the button on the control panel. The electronic igniter is fastened to the control panel.

The apparatus uses three LED lights, one for each control knob. The LED lights with their control circuit function to illuminate the control knobs and the rest of the control panel.

The apparatus may use three tube burners constructed from stainless steel. Each tube burner may be independently adjusted to a desired length. The function of a burner is to produce heat from the combustion of gas hot enough to cook and smoke including woodchips. A tube burner is generally cylindrical in shape and has an open end for gas to enter from a valve and mix with oxygen and a closed end. Gas is forced out through perforations within the burner where it combusts upon exiting. The closed end of the tube is securely fastened to the wall of the keg, but may be mounted onto brackets for the same purpose.

For the heat tent, non-structural stainless steel may be cut and bent into a two dimensional pentagon with the bottom remaining open. End caps matching the pentagonal pattern may be cut from the same material and fastened onto the ends of the two dimensional pentagon to make it three dimensional, with the bottom remaining open. Two mounting brackets per heat tent may be constructed of similar material and fastened to the base above the burners. A hole may be provided on each end cap and bracket in an axial alignment to allow a screw or bolt through to secure the brackets to the three dimensional pentagon to permit rotation and/or movement of the heat tent. When the open side faces the burner, the exterior of the tent faces upward and the heat tent is positioned to deflect grease drippings away from the open flames of the burners to prevent flare-ups. The axial alignment permits rotation and/or movement of the heat tent smoking trough to any degree about its axis. When rotated to about 180 degrees (relative to a prime deflection position), the heat tent faces downward and forms a trough that can be used to hold smoking wood chips to be heated by the burner directly below or adjacent to create smoke flavouring the food. In other embodiments, the shape of the heat tent is can take different forms, where one embodiment has one side of the heat tent being convex, while the other interior side is concave, so that the one side deflects grease while the other side retains burnable/smokable fuels. As noted earlier, the heat tent may be removed from the base.

The grill may be formed from stainless steel rod cut and welded to create a supportive grilling surface designed to fit the interior of the keg. The grill runs flush with the top of the base nearest the control panel. It is held in position by a channel shelf at the back of the base and sits on a shelf attached to the base nearest the control panel. Other mounting/attachment mechanisms may be provided. The grill may be removable from the base.

Holding the grill in place are shelves fastened onto the base nearest the control panel and directly opposite it at the back. The back shelf has a lower portion and an upper portion with a space in between that allows the grill to fit snugly. This prevents the grill from moving down or up. Nearest the control panel a shelf is offset below the opening of the base to allow the top of the grill to sit flush with the opening. On the lid portion nearest the control panel a shelf is fastened flush with the opening. In this way, when the keg body is closed the grill is held firmly in place regardless of the orientation of the apparatus.

Stainless steel fasteners comprising a hook and latch may be fastened onto the keg, one on either side of the control panel. The hook and latch are fastened onto opposite portions of the keg in alignment with each other and so that they are able to function together to latch the keg body shut.

Where the two portions of the keg body, the lid and the base, come together opposite the control panel, hinges fasten the lid and the base together while allowing the lid to open and close. In addition to this primary function the hinges create a gap between the two portions of the keg body acting as a vent to allow exhaust out from the apparatus.

The lid may swing open and back about the hinges when opened by the user until impeded. In order to limit the barbecue from opening wider than desired with the handle out of reach to the user, stops have been fabricated and fastened to the hinges. Each stop consists of a small protruding piece of stainless steel fastened to the hinge that pushes up against the keg body at a designed point to prevent the lid from opening any wider.

The handle of the apparatus may be constructed in part from a beer tap handle. Both ends of the beer tap handle may be secured to a threaded rod that protrudes from the lid near the control panel. Both rods are bent to make this connection between the beer tap handle and the lid. At the lid the threaded rods are fastened, preferably mechanically.

It will be appreciated that the components, modules, structures, forms, shapes, mechanisms and other features of embodiments described herein may be produced using known manufacturing techniques. The names of the components are provided as a convenience to provide labels and assign functions to certain components. It is not required that each component perform only its functions as described above. As such, specific functionalities for each component may be separated and provided by one or more component(s). Components may be contained within other components. Dimensions and compositions of components may be varied in other embodiments from those described herein, unless otherwise noted. Components that are exposed to heat and high temperature have been described herein as being made from metal and/or stainless steel; however any suitably rigid metallic or non-metallic material may also be used.

As used herein, the wording “and/or” is intended to represent an inclusive-or. That is, “X and/or Y” is intended to mean X or Y or both.

Although the disclosure has been described with reference to certain specific embodiments, various modifications thereof will be apparent to those skilled in the art without departing from the scope of the disclosure as outlined in the claims appended hereto.

1. A cooking apparatus comprising:
a base and a lid forming two complimentary sections of a structure, such that when the base and lid are closed, a substantially horizontal cylindrical cooking chamber is defined within the base and lid;
one or more gas burners fitted to sit within the base;
a grill for supporting food fitted to sit above the one or more gas burners; and
a heat tent located above a burner of the one or more gas burners, the heat tent shaped to have an interior volume having an open side and a wall defining a top side opposite the open side, wherein the top side is shaped to have a peak extending away from the open side, wherein the heat tent is movable to:
a first position where the top side faces upward providing a shield for the burner from drippings falling from food being cooked above the heat tent; and
a second position where the top side faces downward and the open side face upward providing trough to hold wood chips for producing smoke for the food being cooked.

2. The cooking apparatus as claimed in claim 1, wherein the wall of the heat tent further comprises:
two side walls extending from the open side that are each connected to the top side.

3. The cooking apparatus as claimed in claim 1, wherein the wall of the heat tent forms a V cross-section.

4. The cooking apparatus as claimed in claim 1, wherein the wall of the heat tent forms a part of a semi-circular cross-section.

5. The cooking apparatus as claimed in claim 1, further comprising:
an end cap on each anterior end of the heat tent, the end cap having a first hole therein;
a bracket attached to the base above the burner, the bracket having a second hole therein; and
a bolt inserted through the first hole and the second hole providing a friction fit for the heat tent within the base.

6. The cooking apparatus as claimed in claim 3, wherein the heat tent is rotatable between the first and the second positions about the bolt.

7. The cooking apparatus as claimed in claim 1, further comprising a screen for the heat tent, located on the open side of the heat tent.

8. The cooking apparatus as claimed in claim 7, wherein the screen is attached to the heat tent with a hinge.

9. A heat tent for covering a burner in a cooking apparatus, the heat tent comprising:
a wall shaped to have an interior volume having an open side and a wall defining a top side opposite the open side, wherein the top side is shaped to have a peak extending away from the open side,
wherein the heat tent is movable in the cooking apparatus to:
a first position where the top side faces upward providing a shield for the burner from drippings falling from food being cooked above the heat tent in the cooking apparatus; and
a second position where the top side faces downward and the open side face upward providing trough to hold wood chips for producing smoke for the food being cooked.

10. The heat tent as claimed in claim 9, wherein the wall of the heat tent further comprises:
two side walls extending from the open side that are each connected to the top side.

11. The heat tent as claimed in claim 9, wherein the wall of the heat tent forms a V cross-section.

12. The heat tent as claimed in claim 9, wherein the wall of the heat tent forms a part of a semi-circular cross-section.

13. The heat tent as claimed in claim 9, further comprising:
an end cap on each anterior end of the heat tent, the end cap having a first hole therein;
a bracket attached to the base above the burner, the bracket having a second hole therein; and
a bolt inserted through the first hole and the second hole providing a friction fit for the heat tent within the base.

14. The heat tent as claimed in claim 13, wherein the heat tent is rotatable between the first and the second positions about the bolt.

15. The heat tent as claimed in claim 9, further comprising a screen for the heat tent, located on the open side of the heat tent.

16. The heat tent as claimed in claim 15, wherein the screen is attached to the heat tent with a hinge.
